(19) United States
(12) Patent Application Publication
(10) Pub. No.: US 2025/0323277 A1
(43) Pub. Date: Oct. 16, 2025

(54) CHARGE CATHODE ASSEMBLY WITH EMBEDDED ELECTRODE MATERIAL FOR USE IN AN ELECTROCHEMICAL CELL

(71) Applicant: e-Zinc Inc., Toronto, (CA)

(72) Inventors: Petrus Theodorus DE KONING, Toronto (CA); Arturo REZA UGALDE, Mississauga (CA); Joel R. HAYES (deceased), Mississauga (CA)

(73) Assignee: e-Zinc Inc., Mississauga, ON (CA)

(21) Appl. No.: 18/865,245

(22) PCT Filed: Jun. 7, 2023
(86) PCT No.: PCT/CA2023/050774

§ 371 Date: Nov. 12, 2024

Related U.S. Application Data
(60) Provisional application No. 63/350,055, filed on Jun. 8, 2022.

(51) Int. Cl. H01M 4/66; H01M 4/04; H01M 4/587; H01M 4/70; H01M 10/28; H01M 10/42

(52) U.S. Cl. CPC H01M 4/667; H01M 4/043; H01M 4/587; H01M 4/668; H01M 4/70; H01M 10/28; H01M 10/4242

(57) ABSTRACT

A charge cathode assembly includes: an electrically conductive plate having a first and second plurality of apertures therein, the second plurality of apertures being through-apertures; a plurality of pellets of a cathode material that is not weldable to the electrically conductive plate, the plurality of pellets embedded in the first plurality of apertures so that a portion of each pellet protrudes from the apertures; and, a non-conductive coating on exterior surfaces of the electrically conductive plate, the non-conductive coating filling spaces between the protruding portions of the plurality of pellets so that end faces of the protruding portions are not coated with the non-conductive coating, the non-conductive coating engaging itself through the second plurality of apertures for securing the non-conductive coating to the electrically conductive plate.

### CROSS-REFERENCE TO RELATED APPLICATIONS

This application claims the benefit of United States Provisional patent application U.S. Ser. No. 63/350,055 filed Jun. 8, 2022, the entire contents of which is herein incorporated by reference.

### FIELD

This application relates to electrochemical cells, in particular to charge cathode assemblies for electrochemical cells.

### BACKGROUND

Typical charge/discharge type electrochemical cells comprise a tank containing a reservoir of electrolyte in which electrodes (cathodes and anodes) are situated, the tank housing a discharging section generally located at or near a bottom of the tank and a charging section generally located at or near a top of the tank, with a storage section located in between the charging and discharging sections. The charging section operates to store electrical energy in the electrochemical cell and the discharging section operates to deliver the stored electrical energy to operate an electrical device. The charging and discharging sections are generally not operated at the same time.

Charge/discharge type electrochemical cells typically utilize Zn/Zn²⁺ half reactions in a basic aqueous electrolyte. The charging section comprises charge anodes and charge cathodes at which the following chemical reactions occur during a charging operation:

### Charge Anode:

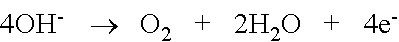

### Charge Cathode:

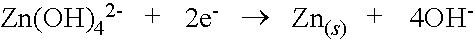

Elemental zinc solid formed at the charge cathode can be removed from the charge cathode by a means of wiping or scraping. The elemental zinc then theoretically falls to the bottom of the electrochemical cell under the influence of gravity to collect on metal current collectors, which carry current to operate electrical devices when the solid zinc is converted back to Zn(OH)₄²⁻ during a discharge operation of the electrochemical cell. However, known zinc removal systems have one or more disadvantages including uneven distribution of force across the charge plate causing zinc to smear across the charge cathode and compact in subsequent wipe cycles producing a hard, crusty zinc deposit eventually causing wiper/scraper breakage; too low of normal force with respect to the charge cathode which eventually results in wiper/scraper breakage; too high of normal force with respect to the charge cathode leading to binding on the charge cathode; and, high power requirements to drive the wiper mechanism decreasing the overall efficiency of the system, and high part costs.

Therefore, there is a need for a charge cathode assembly design that permits efficient removal of deposited metal to overcome deficiencies of wiper systems.

### SUMMARY

A charge cathode assembly for an electrochemical cell, the charge cathode assembly comprising: an electrically conductive plate having a first plurality of apertures therein and a second plurality of apertures therein, the second plurality of apertures being through-apertures; a plurality of pellets comprising a cathode material that is not weldable to the electrically conductive plate, the plurality of pellets embedded in the first plurality of apertures so that a portion of each pellet protrudes from the apertures of the first plurality of apertures; and, a non-conductive coating on all exterior surfaces of the electrically conductive plate except for a busbar tab of the plate, the non-conductive coating filling spaces between the protruding portions of the plurality of pellets so that end faces of the protruding portions are not coated with the non-conductive coating and are exposed to electrolyte in the electrochemical cell during operation of the electrochemical cell, the non-conductive coating engaging itself through the second plurality of apertures for securing the non-conductive coating to the electrically conductive plate.

The pellets act as the charge sites where zinc or other elemental metals are deposited during operation of the electrochemical cell. Therefore, the pellets desirably have low adhesion to zinc and other metals to facilitate wiping when zinc or other metals are deposited at the charge sites. For this reason, metals such as steel (e.g., mild steel) are not desirable at the charge sites as zinc and other metals deposited from the electrochemical cell adhere strongly to metals such as steel (e.g., carbon steel). However, metals such as steel (e.g., carbon steel), copper and brass are desirable to act as a current collector and for their ease of fabrication. Materials that have low adhesion to zinc and other metals are also difficult to attach to metals such as steels by the normal method of welding. Therefore, when the pellets comprise a cathode material that is not weldable to the electrically conductive plate, for example graphite, tin, magnesium and the like, especially graphite, the pellets must be securely connected in another way. While other connectors may be usable, it has been found that embedding the pellets in the first plurality of apertures offers enough security while providing high charge efficiency at high currents. Embedding the pellets preferably involves press fitting the pellets in the first plurality of apertures.

The electrically conductive plate acts as a current collector. The electrically conductive plate can comprise any suitable material that has sufficient mechanical robustness and electrical conductivity to operate in an electrochemical cell. The electrically conductive plate preferably comprises a metal, for example steel, copper or brass. The electrically conductive plate has two surfaces opposed to each other. The electrically conductive plate has the first plurality of apertures therein. The first plurality of apertures can be indentations (i.e., semi-perforations) in one surface of the electrically conductive plate, indentations in both surfaces of the electrically conductive plate or through-apertures between the opposed surfaces of the electrically conductive plate. The first plurality of apertures are preferably through-apertures so that the plurality of pellets protrude from both surfaces of the electrically conductive plate to provide charge sites on both sites of the charge cathode assembly.

The electrically conductive plate has a second plurality of apertures therein. The second plurality of apertures are through-apertures between the opposed surfaces of the electrically conductive plate. The second plurality of apertures act to allow the non-conductive coating that is accessible from the opposing surface to be homogeneous with the non-conductive coating on the opposite surface for improved securement of the non-conductive coating to the electrically conductive plate. Thus, the non-conductive coating fills the second plurality of apertures making a mechanical bond between layers of the non-conductive coating covering the two opposed surfaces of the electrically conductive plate. The second plurality of apertures preferably have a size and spacing sufficient to hold the non-conductive coating in mechanical contact with the conductive elements under thermal expansion/contraction that would otherwise shear the surface-to-surface bond.

The non-conductive coating preferably comprises a robust material that does not conduct electricity. An organic polymeric material is preferred, for example plastics. Thermoplastics and elastomers could be used, but thermoset polymers are preferred for their rigidity. Epoxy resins are particularly preferred. Epoxy resins can be cast and monolithically cured mechanically tying the non-conductive coatings on each surface together through the second plurality of apertures with low tooling investment. Further, the non-conductive coating preferably has a low coefficient of friction to a mated wiper blade when the charge cathode assembly is to be used in an electrochemical cell having an electrode wiping system. The low coefficient of friction to the wiper blade material reduces drive loads resulting from contact of the wiper blade with the non-conductive coating.

To fabricate the charge cathode assembly, the first and second plurality of apertures are milled or punched into a plate of an electrically conductive material with common sheet metal fabrication techniques. Pellets of the cathode material having a suitable cross-sectional shape, (e.g., round, oval, triangular, square, rectangular, hexagonal or any other shape), cross-sectional area and length are inserted into the first plurality of apertures. Then the non-conductive material is coated on all exterior surfaces of the electrically conductive plate, except for a busbar tab of the plate and perhaps any other portions of the plate that would not be exposed to electrolyte and for which there is a need or desire to remain uncoated. The non-conductive material fills spaces between and covers the protruding portions of the plurality of pellets. The non-conductive material also fills the second plurality of apertures forming a stronger bond between the coating of non-conductive material and the electrically conductive plate. The coating of non-conductive material is then milled off the end faces of the pellets to provide exposed charge sites that are flush with the layer of non-conductive material.

Wiping systems suitable for use with the charge electrode wipe metal deposits of material from the charge electrode assembly in the electrochemical cell. The material is an electrodeposited metal, for example zinc, copper, lead and the like. The electrochemical cell comprises a tank for holding an electrolyte in which the charge electrode assemblies are immersed. The wiper system is mounted on the tank so that wiper blades of the wiping system are in contact with the surfaces of the charge electrode assemblies on which material deposits.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a charge electrode assembly suitable for use with a wiper system.

FIG. 1B depicts a section view through A-A in FIG. 1A.

FIG. 2 depicts a second embodiment of a charge electrode assembly suitable for use with a wiper system.

FIG. 3 depicts a third embodiment of a charge electrode assembly suitable for use with a wiper system.

### DETAILED DESCRIPTION

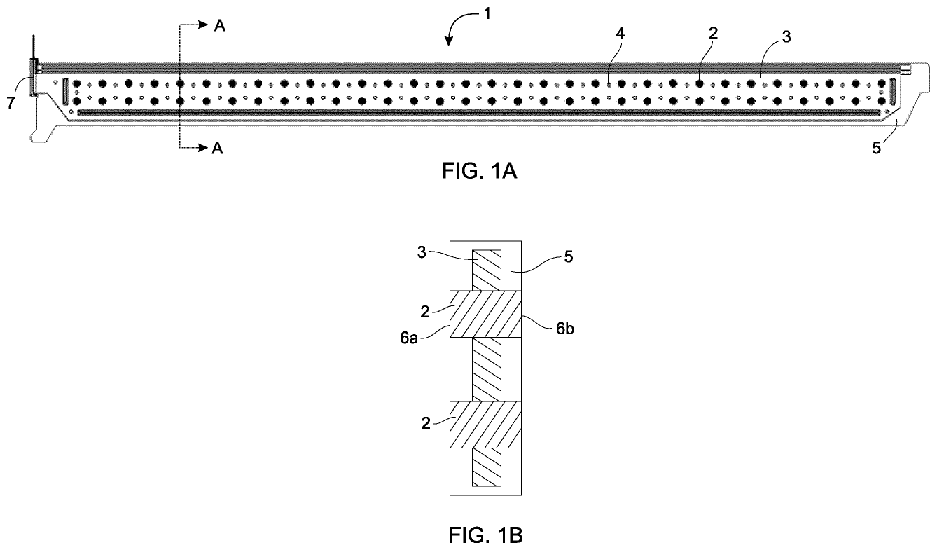

With reference to FIG. 1A and FIG. 1B, a charge electrode assembly 1 comprises a conductive metal plate 3 (current collector) having graphite pellets 2 (only one labeled in FIG. 1A) inserted through through-apertures in the metal plate 3 so that the pellets 2 protrude from both of the opposed surfaces of the metal plate 3. The metal plate 3 is insulated on all exterior surfaces, except an exposed portion 7, with a layer of cured epoxy resin 5 leaving end surfaces 6a. 6b of the pellets 2 exposed but flush with the surface of the layer of cured epoxy resin 5. Smaller through-apertures 4 in the metal plate 3 help secure the layer of cured epoxy resin 5 to the metal plate 3. The exposed portion 7 of the metal plate 3 is connectable to a bus bar of the electrochemical cell. The exposed portion 7 is not coated by the layer of cured epoxy resin 5.

The graphite pellets 2 offer discrete electrodeposition sites. Preferably, the graphite pellets are round and have diameters in a range of 0.1-10 mm, more preferably 1.0-6.5 mm, although oval, triangular, square, rectangular, hexagonal and other shapes can also be used.

The electrode assembly 1 has high electrical conductivity, low adhesion of zinc to the charge sites for easy zinc removal, and simplicity to adjust arrays of the electrochemical cell according to electrode design requirements for different applications. Surface area, active site distribution, size and shape of the electrode assembly 1 can be easily adjusted to change the operating conditions for different applications. Bench-scale tests were performed using charge cathode assemblies of two graphite diameters, 1 mm and 6.35 mm, under variable current densities, zincate concentration, and wiping intervals. The results showed low adhesion of zinc even at low currents and high charge efficiency at high currents.

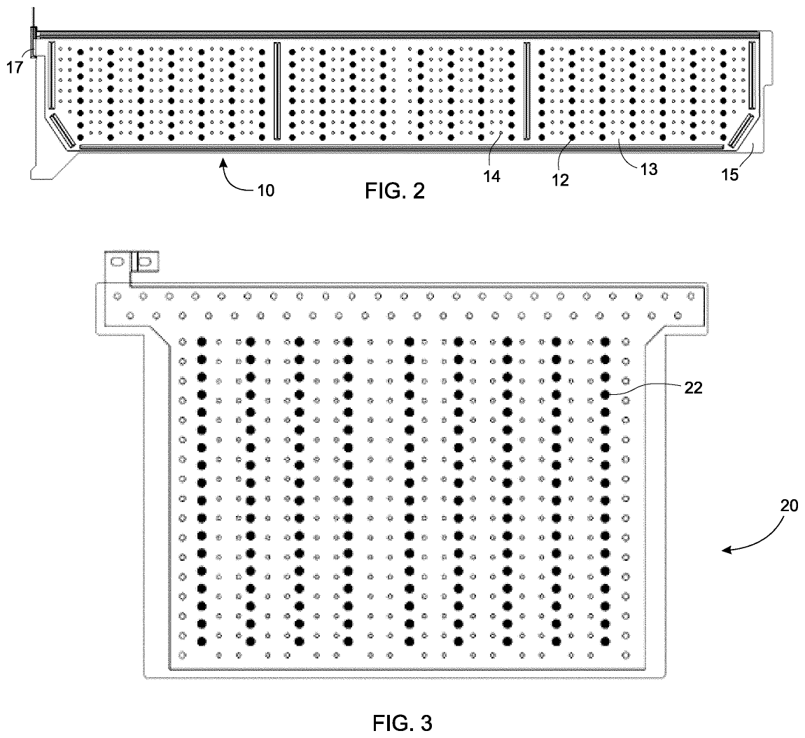

With reference to FIG. 2 a second embodiment 10 of a charge electrode assembly is suitable for use with wiper systems that have longer wiper blades than the ones used for charge electrode assembly 1. The electrode 10 also comprises a conductive metal plate 13 (current collector) having graphite (cathode) pellets 12 (only one labeled) inserted through through-apertures in the metal plate 13 so that the pellets 12 protrude from both of the opposed surfaces of the metal plate 13. The metal plate 13 is insulated on both faces with a layer of cured epoxy resin 15 leaving end surfaces of the pellets 12 exposed but flush with the surface of the layer of cured epoxy resin 15. Smaller through-apertures 14 in the metal plate 13 improve adhesion between the layer of cured epoxy resin 15 and the metal plate 13. An exposed portion 17 of the metal plate 13 is connectable to a bus bar of the electrochemical cell. The exposed portion 17 is not coated by the layer of cured epoxy resin 15.

With reference to FIG. 3, a third embodiment 20 of a charge electrode assembly is suitable for use with wiping systems that use yet longer wipers than the ones used for charge electrodes 1 and 10. The charge electrode 20 comprises more rows of graphite (cathode) pellets 22 than either of the other two charge cathode assemblies 1 and 10.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A charge cathode assembly for an electrochemical cell, the charge cathode assembly comprising:
an electrically conductive plate having a first plurality of apertures therein and a second plurality of apertures therein, the second plurality of apertures being through-apertures;
a plurality of pellets comprising a cathode material that is not weldable to the electrically conductive plate, the plurality of pellets embedded in the first plurality of apertures so that a portion of each pellet protrudes from the apertures of the first plurality of apertures; and,
a non-conductive coating on all exterior surfaces of the electrically conductive plate except for a busbar tab of the plate, the non-conductive coating filling spaces between the protruding portions of the plurality of pellets so that end faces of the protruding portions are not coated with the non-conductive coating and are exposed to electrolyte in the electrochemical cell during operation of the electrochemical cell, the non-conductive coating engaging itself through the second plurality of apertures for securing the non-conductive coating to the electrically conductive plate.

2. The cathode assembly of claim 1, wherein the electrically conductive plate has opposed surfaces, the first plurality of apertures are through-apertures between the opposed surfaces, a single pellet of the cathode material is inserted into each through-aperture of the first plurality of apertures and protrudes from both opposed surfaces, and the non-conductive coating coats both opposed surfaces between the protruding portions of the plurality of pellets.

3. The cathode assembly of claim 1, wherein the electrically conductive plate has opposed surfaces, the first plurality of apertures are indentations in the opposed surfaces, each indentation has a pellet of the cathode material inserted therein so that the plurality of pellets protrude from the opposed surfaces, and the non-conductive coating coats both opposed surfaces between the protruding portions of the plurality of pellets.

4. The cathode assembly of claim 1, wherein the cathode material comprises graphite.

5. The assembly cathode assembly of claim 1, wherein the plate comprises a metal.

6. The cathode assembly of claim 1, wherein the non-conductive coating comprises an epoxy resin.

7. The cathode assembly of claim 1, wherein the plurality of pellets are press fitted into the first plurality of apertures.

8. The cathode assembly of claim 1 where the non-conductive coating also has a low coefficient of friction to a mated wiper blade when the charge cathode assembly is to be used in an electrochemical cell having an electrode wiping system.
